(19) United States
(12) Patent Application Publication
(10) Pub. No.: US 2015/0170033 A1
(43) Pub. Date: Jun. 18, 2015

(54) CONTEXT REASONING APPARATUS, CONTEXT RECOGNITION SYSTEM AND CONTEXT REASONING METHOD

(71) Applicant: Electronics and Telecommunications Research Institute, Daejeon (KR)

(72) Inventors: Sang-Keun RHEE, Daejeon (KR); Hyoung-Sun KIM, Daejeon (KR); Young-Ho SUH, Daejeon (KR); Kang-Woo LEE, Daejeon (KR)

(21) Appl. No.: 14/540,683

(22) Filed: Nov. 13, 2014

(30) Foreign Application Priority Data
Dec. 13, 2013 (KR) 10-2013-0155809

(51) Int. Cl. G06N 5/02

(52) U.S. Cl. CPC G06N 5/02

(57) ABSTRACT

The present invention relates to a context reasoning method and apparatus. A context reasoning apparatus include a model constructing unit configured to construct a context representation model using spatio-temporal attribute information for a plurality of objects existing in observational space; and a context reasoning unit configured to recognize current context by performing context reasoning based on the context representation model and generating events related to the current context, wherein the context representation model is composed with an observation layer in which temporal attribute and spatial attribute information for the objects is represented, a syntactic layer in which complex information, provided from the information represented in the observation layer, is represented, and a semantic layer in which semantic information, provided through combination and analysis of the information represented in the observation layer and the syntactic layer is represented.

### CROSS REFERENCE TO RELATED APPLICATION

This application claims the benefit of Korean Patent Application No. 10-2013-0155809, filed on Dec. 13, 2013, entitled “Context representation model and context reasoning method and apparatus based on the same model”, which is hereby incorporated by reference in its entirety into this application.

### BACKGROUND OF THE INVENTION

1. Technical Field

The present invention relates to a context representation model and a context reasoning method and apparatus based on the same model and more particularly, to a context representation model built based on spatio-temporal attribute information of objects existing in the space observable by a context recognition system, and a current context reasoning method and apparatus based on the context representation model.

2. Description of the Related Art

Development research is currently under way on obtaining and analyzing information through various sensors or input devices to provide desired environment information, and providing appropriate information or performing services or tasks or behavior based on the environment information in the filed relating to intelligent systems. Such applications have been applied in various types of mobile devices such as smart phones, tablets and the like, intelligent service robots, smart homes and the like, beyond simple computer systems.

Among such intelligent systems, a technology, which is able to store and represent each information efficiently and analyze it semantically so that a system is capable of semantically analyzing and understanding context information, is highly demanded in order to provide services actively without direct order input by a user or in order to response more intelligently to a user's specific order.

### SUMMARY OF THE INVENTION

Exemplary embodiments of the present invention provide a context representation model, which is a core technology to implement a context recognition intelligent system having application extendibility, and further to provide a context reasoning apparatus and method based on the context representation model.

Exemplary embodiments of the present invention define spatio-temporal objects which may be constitutional materials of context information in recognition of context by using information produced from objects existing on spatio-temporal phase observable by a context recognition system, and efficient classification thereof. Exemplary embodiments of the present invention provide a context representation model which allows semantic representation of the information for the defined spatio-temporal objects, and a context reasoning apparatus and method based on the model.

A context reasoning apparatus according to an embodiment of the present invention includes a model constructing unit configured to construct a context representation model using spatio-temporal attribute information for a plurality of objects existing in observational space; and a context reasoning unit configured to recognize current context by performing context reasoning based on the context representation model and generating events related to the current context, wherein the context representation model is composed with an observation layer in which temporal attribute and spatial attribute information for the objects is represented, a syntactic layer in which complex information, provided from the information represented in the observation layer, is represented, and a semantic layer in which semantic information, provided through combination and analysis of the information represented in the observation layer and the syntactic layer, is represented.

In an embodiment, the object may include at least one from a physical object, an object being represented on a display and an object augmented on mixed reality.

In an embodiment, the object may be classified into a static object, a semi-static object, a dynamic object and a volatile object according to changes in situational attribute and spatial attribute with time.

In an embodiment, the context representation model includes an object knowledge model, a spatial model, a temporal model, and a context model, wherein each of the object knowledge model, the spatial model, the temporal model may be represented in a layered structure composed with the observation layer, the syntactic layer and the semantic layer.

In an embodiment, the observation layer of the object knowledge model may include identification information and private attribute information of an object, the syntactic layer may include situational information of an object and syntactic relation information between objects, and the semantic layer may include semantic relation information between objects.

In an embodiment, the observation layer of the spatial model may include map information of the observational space, and position and orientation information of the object existing in the space, the syntactic layer may include mereological/topological information in accordance with mutual positions between the objects, which is the information provided through combination operation of the information included in the observation layer, orientation information between objects and distance information between objects, and the semantic layer may include semantic relation information representing the information of the observation layer and syntactic layer according to a predetermined spatial relation rule.

In an embodiment, the observation layer of the temporal model may include timestamp, the syntactic layer may include interval information and temporal topology information according to a predetermined criteria, and the semantic layer may include relative temporal relation information representing the information of the observation layer and syntactic layer according to a predetermined temporal relation rule.

In an embodiment, the context model is represented as the semantic layer, and includes context knowledge provided by combining the information included in the spatial model, the object knowledge model and the temporal model and reasoning rules according to applications and services.

A context recognition system according to an embodiment of the present invention includes an information gathering apparatus collecting temporal and spatial attribute information for a plurality of objects from the observation data; a knowledge representation and reasoning apparatus constructing a context representation model using the temporal and spatial attribute information, recognizing current context by performing context reasoning based on the context representation model, and generating an event relating to the current context; and a service providing apparatus determining an action to be performed by being corresponded to the event generated by the knowledge representation and reasoning apparatus, wherein the context representation model is composed with an observation layer in which temporal attribute and spatial attribute information for the objects is represented, a syntactic layer in which complex information, provided from the information represented in the observation layer, is represented, and a semantic layer in which semantic information, provided through combination and analysis of the information represented in the observation layer and the syntactic layer, is represented.

According to an embodiment of the present invention, there is provided a context reasoning method based on context representation model composed with an observation layer, a syntactic layer and a semantic layer. The method may include generating observation layer information by using observation data collected in real time to the observational space; generating syntactic layer information by performing spatial reasoning based on the observation layer information; performing temporal reasoning by using the observation layer information and the syntactic layer information generated at the current point or for a certain period of time; and producing current context information according to a predetermined reasoning rule by combining at least one information of the observation layer information, the syntactic layer information and the information provided according to temporal reasoning, and performing semantic reasoning.

In an embodiment, the step of performing temporal reasoning may perform at least one chosen from an instant analysis using only information at the current point, a short-term analysis analyzing information records for a certain period of time, and a long-term analysis analyzing information records for a long period of time.

According to an embodiment of the present invention, a context model may be made based on spatio-temporal information of objects existing in actual or virtual space and desired context may be obtained through step-wise reasoning processes.

The present invention provides definition and classification of spatio-temporal objects which are materials of context reasoning, allows utilizing not only observation data which is collected in real-time/consistently through a hierarchical context model but also relatively fixed background knowledge which is necessary to use it, and allows setting a different information processing unit for each layer.

Each object and spatial and temporal information may be used for reasoning efficiently to overall context reasoning processes by constructing the hierarchical context representation model according to the present invention.

### BRIEF DESCRIPTION OF THE DRAWINGS

FIG. 1 illustrates configuration of a context recognition system in which context representation model of the present invention can be used.

FIG. 2 illustrates structure of a context representation model according to an embodiment of the present invention.

FIG. 3 is a flowchart illustrating a context reasoning process according to an embodiment of the present invention.

FIG. 4 is a block view illustrating a computer system in which a context reasoning process according to an embodiment of the present invention is implemented.

### DESCRIPTION OF THE EXEMPLARY EMBODIMENTS

While the present invention will be described with reference to particular embodiments, it is to be appreciated that various changes and modifications may be made by those skilled in the art without departing from the spirit and scope of the present invention, as defined by the appended claims and their equivalents.

Throughout the description of the present invention, when describing a certain technology is determined to evade the point of the present invention, the pertinent detailed description will be omitted.

Unless clearly used otherwise, expressions in the singular number include a plural meaning.

Furthermore, “module”, “unit”, “interface” and the like among the terms used in the description are usually computer-related objects, for example, it means hardware, software and a combination thereof.

There are a variety of models for representing context information, such as Key-Value model, Markup Model, Graphical Model, Object-oriented Model, Logic Model, and Ontology-based Model, etc. Recently, since context information which a system deals with has been complicated, researches are being carried to use a combination of several types of models. Theoretical basis of representation systems has been generated to some degree to describe context information as such, but it requires more particular knowledge representation models based on such theories in order to implement actual context recognition systems. Conventional technologies are too general to implement actual context recognition systems or may not be applied to different aspects since they are limited to predetermined environments and certain services.

With respect to analysis and reasoning of context information, there are traditional machine learning technologies, logic-based reasoning technologies, which rev up with semantic web technologies, and recently introduced big data-based analysis and reasoning technologies. However, such conventional technologies still work for limited types of context information in implementation to actual systems. Therefore, there is still high demand to develop models which can be applied more widely.

For this purpose, the present invention defines spatio-temporal objects which may be constitutional materials of context information in recognition of context by using information produced from objects existing on spatio-temporal phase observable by a context recognition system, and efficient classification thereof. The present invention also provides a context representation model which allows representation of the information semantically for the defined spatio-temporal objects, and a context reasoning apparatus and method based on the model at the same time.

[Context-Based Service Provision Process]

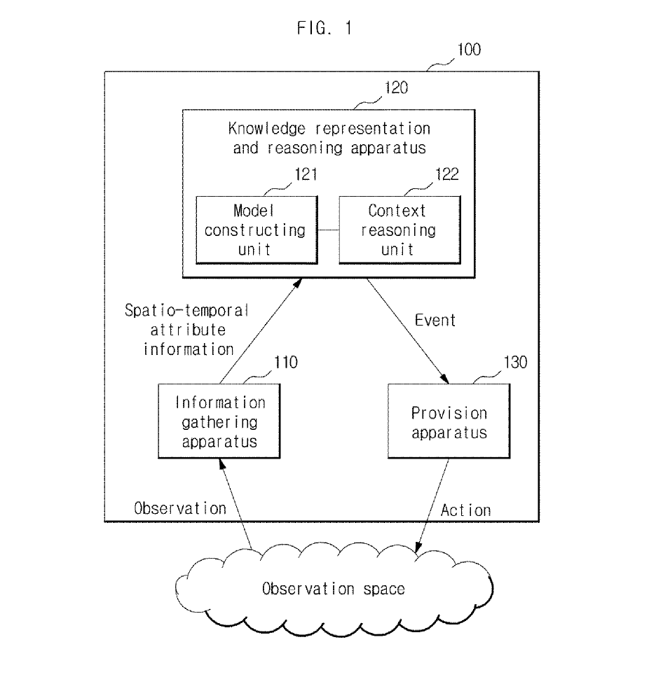

FIG. 1 illustrates configuration of a context recognition system in which a context representation model of the present invention can be used.

Observational space means actual space or virtual space which can be observed or recognized by a context recognition system 100.

The context recognition system 100 may include an information gathering apparatus 110, a knowledge representation and reasoning apparatus 120 and a service provision apparatus 130.

The information gathering apparatus 110 collets observation data for objects existing in observational space which are obtained through different information input devices and/or sensors, and sends situational information generated through the preliminary analysis for the collected observation data to the knowledge representation and reasoning apparatus 120.

In an embodiment, the knowledge representation and reasoning apparatus 120 may include a model constructing unit 121 that constructs a context representation model of the present invention using the situational information of the objects collected by the information gathering apparatus 110, and a context reasoning unit 122 that performs context reasoning based on the constructed context representation model and generates an event related to the reasoned context.

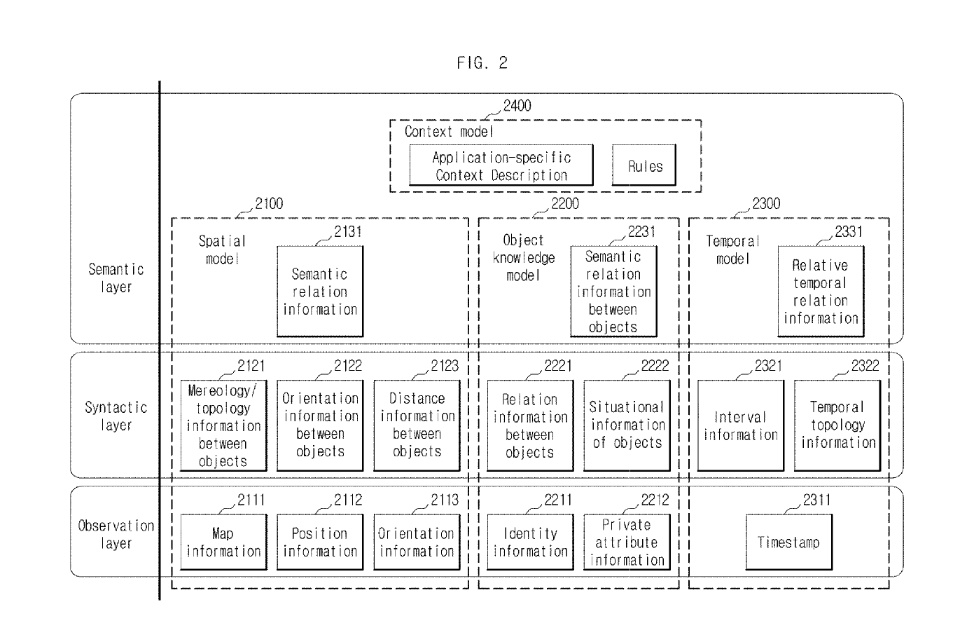

In an embodiment, the context representation model of the present invention is produced based on spatio-temporal attribute information of the objects existing in the observational space and this producing process is performed through rule-based connection between records for dynamic flow of object information and static background knowledge. The context representation model of the present invention will be explained with reference to FIG. 2.

The service providing apparatus 130 determines and performs actions, which the system should provide, based on the events generated by the knowledge representation and reasoning apparatus 120. A plan of performing actions can be also set. The action result may be shown in the observational space.

[Spatio-Temporal Object]

A context representation model and reasoning according to the present invention is based on spatio-temporal information of the objects existing in the observational space. In the specification of the present invention, such an object is called as a ‘spatio-temporal object’ and is an actual object or a virtual object which exists or may exist within the range observable by a system. That is, the spatio-temporal object includes any object having or capable of having temporal and/or spatial attribute and further includes an object being represented on a display and/or an object augmented on mixed reality in addition to a physical object.

Such spatio-temporal objects may be classified into a static object, a semi-static object, a dynamic object and a volatile object according to changes in situational attribute and spatial attribute with time. This classification is not an absolute standard and thus, even the same objects may be belonged to a different category according to purpose and scope of services. A part, a combination of the classification systems, or further divided classification systems may be used if necessary for implementation.

The static object means a fixed object of which situational attribute or spatial attribute is not at all or little affected with time. For example, when a room is recognized as a whole space in smart space and modeling is performed, wall, door, window, and the like are static objects. Such objects are changed with entire remodeling of the room, but in the view of the system, since it is considered as reconstitution of the whole space, one room which is a given space may be considered as a fixed object.

The semi-static object means an object of which attribute value may change with time but such changes are not happened often. Changes in attribute occur during a long period of time but it may be considered as a fixed object like a static object within the unit time range determined for applications or services. For example, when the room is remodeled, desk, bed, book case and the like may be considered as the semi-static object.

The dynamic object means an object which changes during the unit time range determined for applications or services. For example, augmented book, cup, pen, person and the like in an actual or image form may be considered as the dynamic object. In the view of context recognition, attribute values of the dynamic objects have a decisive effect on determining current context.

The static object, the semi-static object and the dynamic object have their own attributes regardless of presence or absence in the current space and time, while a volatile object means an object which has attributes determined for applications or services by appearing temporary but disappearing when its own action ends. For example, when users play a tic-tac-toe game, O or X drawn on the paper in the game service are objects having certain meanings, but O or X itself is a simple symbol which may not be considered as an existing object. Thus, O or X may be appeared as a volatile object during the service. In addition to such virtual objects, when an actual object, such as go stones having a limited specific meaning in services such as board games or tactic games, is used, the go stone may be considered as a volatile object having a limited specific attribute for the service, not as a dynamic object having its own native attribute.

The static object and the semi-static object among 4 spatio-temporal objects are used as background knowledge for surrounding environment, and a background map may be made based on such information for the space observable by a context recognition system. Also changes in situation and position attributes of semi-static objects may be treated with updates of the background map.

Basic context information for the space may be produced with the information of the background map but it may be limited as background information for providing application services. Context necessary for actual applications may be produced from appearances or movements of dynamic objects and volatile objects in the space.

When space is limited to a certain range, static or semi-static objects are considered as regions instead of objects after observation and analysis for static or semi-static objects, and the rest dynamic and volatile object may be considered as spatio-temporal objects.

[Context Representation Model]

FIG. 2 illustrates structure of a context representation model according to an embodiment of the present invention.

A context representation model of the present invention may include a spatial model 2100, an object knowledge model 2200, a temporal model 2300 and a context model 2400. The spatial model 2100, the object knowledge model 2200 and the temporal model 2300 are represented in a layered structure comprised of an observation layer, a syntactic layer and a semantic layer. The context model 2400 may be represented in a semantic layer. The context representation model shown in FIG. 2 illustrates only the part for representing temporal object-based context of the present invention. In actual implementation, domain models corresponding to each knowledge domain and other external knowledge bases may be included.

The observation layer is the first information without any determination through reasoning so that temporal and spatial attribute information of objects which change with time may be logged in a data steam format.

The syntactic layer is represented with complex information obtained through a mechanical operation for the information represented in the observation layer according to predetermined, generic and common standards.

The semantic layer is represented with semantic information which is combined and analyzed information of the observation layer and the syntactic layer. The information represented in the observation layer and the syntactic layer does not change much according to services or applications and thus is considered as information which may be interpreted objectively and independently to some degree, while the information represented in the semantic layer may be changed in reasoning rules for information composition or contents, depending on purposes or directions of services or applications.

Various types of knowledge models included in the context representation model will be explained below.

A spatial model 2100 is a model to represent background knowledge of observational space and spatial attribute information of each spatio-temporal object, and has a layered structure including an observation layer, a syntactic layer and a semantic layer. The observation layer includes map information for the overall structure of the observational space and primary observation information for position and orientation of each object existing in the corresponding space. The map information 2111 defines a coordinate system and direction for the overall space, the position information 2112 represents the position of each object existing in the corresponding space as a coordinate, and the orientation information 2113 defines orientation of each object.

Information of the static and the semi-static objects among observed and represented spatial attribute information of the objects is added to the map information to represent background knowledge for the observational space.

Information obtained through combination operation of the information represented by the observation layer is represented in the syntactic layer of the spatial model 2100. For example, the information may include mereological/topological information 2121, orientation information between objects 2122 and distance information between objects 2123 according to mutual position.

Semantic relation information 2131, which represents the information of the observation layer and the syntactic layer according to a predetermined spatial relation rule, is included in the semantic layer of the spatial model 2100. The semantic relation information 2131 is considered that spatial relationship between the objects in the observational space is interpreted in human's eyes. For example, semantic spatial relationship interpretations such as “close”, “far”, “close to left”, “to an opposite direction” and the like may be produced and represented from combination of information of sub-layers. When more expanded geographic information, instead of limited space, is included, an external GIS database may be coupled with the spatial model 2100.

The object knowledge model 2200 represents information for each object existing in the observational space or each necessary spatio-temporal object, and additional information related thereto. In an embodiment, the spatio-temporal object may include a static object, a semi-static object, a dynamic object and a volatile object. In addition, the spatio-temporal object may be represented by using a classification system such as agents, physical objects, social objects and the like at the same time. Here, the each class is not mutually exclusive so that it may have common elements each other.

Identity information 2211 and private attribute information 2212 for each object may be represented in the observation layer of the object knowledge model 2200. Relation information between objects 2221 and situational information of objects 2222 may be represented in the syntactic layer and semantic relation information between objects 2231 in the semantic layer. An example of syntactic relationship among relation information between objects may be part-of-relation of ‘a door handle is a part of door’ and that of semantic relationship may be ‘a pen is used to write on the paper’.

The temporal model 2300 represents information about time when context related to each object existing in the observational space occurs.

The temporal model 2300 may include timestamp which represents current time and interval information which represents changes in movement of an object, performance of action, progression of an event and the like. Timestamp 2311 may be represented in the observation layer. Interval information 2321, divided by a constant interval or any standard, and temporal topology information 2322 between the timestamp 2311 and the interval information 2321 are represented in the syntactic layer. Semantic information such as information of “fast”, “current”, “a long time ago”, “early” and the like from interpretation of the timestamp 2311, the interval information 2321 and the temporal topology information 2322 and relative temporal relation information 2331 occurring through interconnection between time and space and between time and object are represented in the semantic layer.

Application-specific context description 2410, produced by combination of information in the spatial model 2100, the object knowledge model 2200 and the temporal model 2300, and reasoning rules 2420 according to applications and services are represented in the context model 2400. Context information is represented in which the context information is recognized finally by a system through combining object knowledge information, spatial knowledge and temporal knowledge information and interpreting the combined information according to reasoning rules. Accordingly, the reasoning rules 2420 define what the combination of the object knowledge, the temporal knowledge and the spatial knowledge means in the view of applications and services. For example, in case that a user takes rest and uses an application providing a music playing service, a context of ‘a user is resting’ rule may be defined by combining objects, relative position between the objects and time, such as ‘when a user is sitting on a table and a cup of coffee is on the table and neither a book or a note is on the table for at least one minute, the user is resting.’

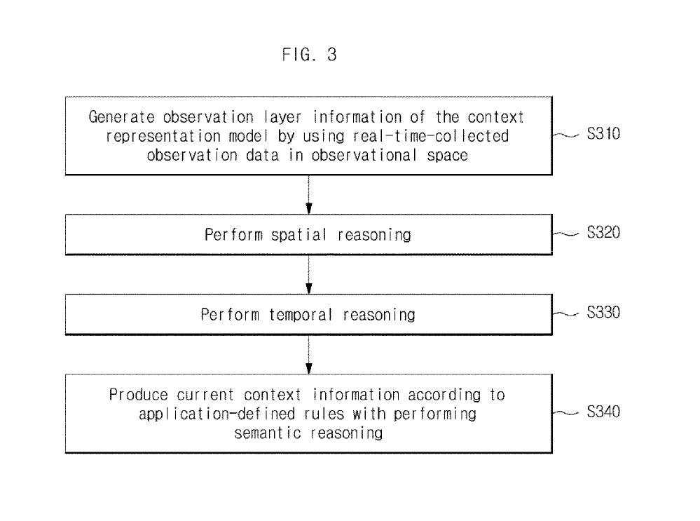

FIG. 3 is a flowchart illustrating a context reasoning process according to an embodiment of the present invention

In Step 310, observation layer information of the context representation model is generated by using real-time-collected observation data in observational space. In an embodiment, identification information and spatio-temporal attribute information of each object are determined from the observation data and logged in the observation layer information of a context representation model. Position information and temporal information relating thereto of each object are logged in the observation layer of the temporal model and spatial model.

In addition, syntactic layer information of the object knowledge model may be generated by figuring situational information of objects and/or syntactic relation information between objects.

The object situational information 2222 is attribute which an object itself has, excluding particular position and/or temporal attribute of the object. For example, all objects may generally have situation of present/absent in certain space or moving/stopping. In case of an electronic such as electric light, TV or audio equipment, etc., setting information such as channel, volume, brightness and the like in addition to situation of “On/Off”, “terrestrial mode/external input mode’, ‘executing an audio file/playing CD/playing radio’ and the like may be represented as situational information of objects. In case of an object which is not an electronic, individual situational information may be defined. For example, in case of paper, situation of “flattened, folded, crumpled and the like” may be defined. In Step 310, current situation of a corresponding object among situational attributes which are predefined for each recognized object is recognized and logged.

Part-of relation is representative as information of the syntactic relationship between objects 2221. This information is first logged at the step of inputting object information recognizable by the system and is then determined if the relation between objects is maintained the same as it is logged or is damaged, separated, combined or changed through observation in Step 310.

In Step 320, spatial reasoning is performed for the information logged in Step 310 and provide mereological/topological information according to mutual position, orientation information between objects and distance information between objects to generate syntactic layer information of the spatial model.

Distance information between objects 2123 is obtained through geometry operation using the position information between objects 2112

Orientation information between objects 2122 is obtained through the position information of each object 2112 as mutual position orientation information such as “object A is located at 1 o'clock of another object B” by defining coordinate and direction for the observational space. Additional mutual orientation information may be also obtained such as “an object B is located at 12 o'clock of another object A (front) on the basis of the object A along with using the object itself orientation 2113. This information is also logged in the orientation information between objects 2122.

Observation and various spatial relationship logics are used to produce and represent the mereology/topology information between objects 2121. Methods which may be used here include Egenhofer's spatial topology method, region connection calculus (RCC), dimensionally extended nine-intersection model (DE-91M), ISO standard simple feature access (ISO 19125) and GeoSPARQL, etc.

Complex syntactic spatial information such as “an object A is facing and 2 meter apart from an object B at 8 o'clock” and “an object A is overlapped on the right 10 cm of an object B” may be also produced by combining the information such as mereology/topology information, orientation information between objects, and distance information between objects of the syntactic layer of knowledge models between spaces generated through the above-described process.

In Step 330, temporal reasoning is performed using the observation layer information, the syntactic layer information generated at the previous steps of Step 310 and Step 320 at current point or for a period of certain unit time, and changed information collected from the past. The temporal reasoning includes an instant analysis using only context information of current time, a short-term analysis analyzing context information for a certain period of time, and a long-term analysis analyzing context information for a long period of time. This is similar concept to the Atkinson-Shiffrin model defining that the human memory has sensory memory (register), short-term memory (store), an long-term memory (store) and the Baddeley's working memory model which is expanded concept of the Atkinson-Shiffrin model's. Such models proposed to understand human cognitive functions are used for modeling and implementing intelligent systems.

The temporal reasoning, unlike the previous steps, is to draw semantic context, instead of drawing information of a particular part of a model, by considering history, context and repeatability of situational information of each object to understand better for the meaning of current context and to predict future context.

The temporal reasoning, which is divided into 3 steps, may apply all steps or a part thereof depending on applications. The context information may be produced through only information of objects and their spatial attribute information, excluding the temporal reasoning depending on applications.

The instant analysis draws context through the information collected at the current moment without considering previous situational information. Although it may seem like reasoning context excluding the temporal reasoning process, this analysis is a process of reasoning context using object information and spatial information plus timestamp so that it may provide different result from that provided when the temporal reasoning process is excluded. Namely, if identical objects are present at the same position with the same state, it may be the same context when the temporal reasoning process is excluded, but if the instant analysis in the temporal analysis process is conducted, meaning of context may be interpreted differently according to time such as in the morning or in the evening, or week day or weekend.

The short-term analysis records all the information of state changes for a certain period of time and understands the meaning of current context therefrom in which the certain period of time may be defined according to applications and services. In the short-term analysis, not only temporal information corresponding at the current point but also interval information 2321 for each event produced by state and position changes of each object are important factors. When a plurality of events are generated by many objects, information of the temporal topology 2322 between interval information such as information about that duration of an event overlaps partly or is included to that of another is produced to operate context reasoning. The Allen's Interval Algebra and temporal logics including interval temporal logic (ITL), temporal logic of actions (TLA), and duration calculus (DC) may be used to provide temporal topology. Module and/or algorism to produce information of the spatial mereology/topology 2121 in Step 320 of spatial reasoning may be used by interpreting time as 1D-unilateral space, instead of employing separate module and/or algorism.

The long-term analysis draws context using all information collected through observation accumulated for a long period of time, reasoning, services and other methods. The period is relatively longer than that for the short-term analysis. Only the information corresponding to a certain period from the accumulated information or all the information may be used depending on applications and systems for an accurate period. Therefore, when a system including the long-term analysis process is implemented, it requires additional storage to collect and manage information with time in which the storage may include information of the observation layer and the syntactic layer of knowledge models, semantic context information, which is reasoned in the past and is information of the semantic layer, information of performed application and service history, and additionally collected or inputted information. Data mining and machine learning may be used as a long-term analysis method for such information. Big data analysis and processing method may be also used.

In implementing the step of temporal reasoning, it may be implemented without temporal reasoning depending on services or applications as mentioned above or a part or all of the instant analysis, the short-term analysis, and the long-term analysis may be used. Reasoning may be performed by setting a different time unit for each layer for the temporal reasoning according to a layered model including an observation layer, a syntactic layer, and a semantic layer. Reasoning may be also performed by setting a different time unit for a sub-model which is divided into a spatial model, an object model, a temporal model, and a context model. Reasoning may be also performed by setting a different analysis among the instant analysis, the short-term analysis, and the long-term analysis partially or all for each layer or the sub-model. Stream data processing and management and stream reasoning which are key technologies to analyze data considering time can be also used.

In Step 340, current context information is provided by a logic reasoning process according to application-defined rules with performing semantic reasoning through combining all information generated in Step 310 to Step 330 and various data analysis processes described in the step of temporal reasoning. A part of reasoning processes may be omitted or be selected according to applications. The context finally obtained through the processes is used for generating events desired to the system and the result is then sent to the service providing apparatus 130 for the system to perform operations.

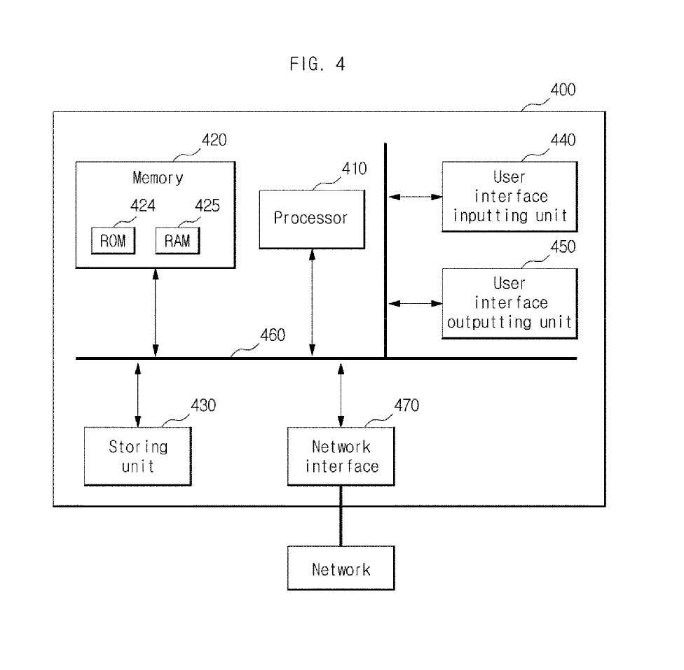

The exemplary embodiment of the present invention can be implemented in the form of computer executable instructions and recorded in a memory of a computer system. As shown in FIG. 4, a computer system 400 may include at least one of one or more processors 410, a memory 420, a storage 430, a user interface inputting unit 440 and a user interface outputting unit 450, which can communicate with each other through a bus 460. The computer system 400 may further include a network interface 470 to connect to network. The processor 410 may be CPU or semiconductor element that executes instructions stored in the memory 420 and/or the storage 430. The memory 420 and the storage 430 may include various types of volatile/non-volatile recording media. For example, the memory may include ROM 424 and RAM 425.

The context reasoning methods according to the above-described exemplary embodiments of the present invention can be implemented in the form of computer-executable instructions and recorded in the memory 420 and/or the storage 430. When the instructions are executed by the processor 410, the method according to at least one exemplary embodiment of the present invention can be performed.

In addition, an apparatus and method according to exemplary embodiments of the present invention may be implemented in the form of program instructions that can be executed by various computer means and may be recorded in a computer-readable medium. The computer-readable medium can include a program instruction, a data file, a data structure, etc., solely or in a combined manner.

The program instruction recorded in the computer-readable medium may be specially designed and configured for the present invention, or known and available to those of ordinary skill in the field of computer software. Examples of the computer-readable medium include magnetic media, such as a hard disk, a floppy disk, and a magnetic tape, optical media, such as a CD-ROM and a DVD, magneto-optical media, such as a floptical disk, and hardware devices, such as a ROM, a RAM, and a flash memory, specially configured to store and perform program instructions. The above-described medium may also be a transmission medium, such as light, a metal wire, or a waveguide including carrier waves that send signals for designating program instructions, data structures, and so on. Examples of the program instructions may include high-level language codes executable by a computer using an interpreter, etc. as well as machine language codes made by compilers.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A context reasoning apparatus comprising:
a model constructing unit configured to construct a context representation model using spatio-temporal attribute information for a plurality of objects existing in observational space; and
a context reasoning unit configured to recognize current context by performing context reasoning based on the context representation model and generating events related to the current context,
wherein the context representation model is composed with an observation layer in which temporal attribute and spatial attribute information for the objects is represented, a syntactic layer in which complex information, provided from the information represented in the observation layer, is represented, and a semantic layer in which semantic information, provided through combination and analysis of the information represented in the observation layer and the syntactic layer is represented.

2. The context reasoning apparatus of claim 1, wherein the object comprises at least one from a physical object, an object being represented on a display and an object augmented on mixed reality.

3. The context reasoning apparatus of claim 1, wherein the object is classified into a static object, a semi-static object, a dynamic object and a volatile object according to changes in situational attribute and spatial attribute with time.

4. The context reasoning apparatus of claim 1, wherein the context representation model includes an object knowledge model, a spatial model, a temporal model, and a context model,
wherein each of the object knowledge model, the spatial model, the temporal model is represented in a layered structure composed with the observation layer, the syntactic layer and the semantic layer.

5. The context reasoning apparatus of claim 4, wherein the observation layer of the object knowledge model includes identification information and private attribute information of the object, the syntactic layer includes situational information of the object and syntactic relation information between the objects, and the semantic layer includes semantic relation information between the objects.

6. The context reasoning apparatus of claim 4, wherein the observation layer of the spatial model includes map information of the observational space and position and orientation information of the object existing in the space,
the syntactic layer includes mereological/topological information in accordance with mutual position between the objects, which is the information provided through combination operation of the information included in the observation layer, orientation information between objects and distance information between objects, and
the semantic layer includes semantic relation information representing the information of the observation layer and syntactic layer according to a predetermined spatial relation rule.

7. The context reasoning apparatus of claim 4, wherein the observation layer of the temporal model includes timestamp,
the syntactic layer includes interval information and temporal topology information according to a predetermined criteria, and
the semantic layer includes relative temporal relation information representing the information of the observation layer and syntactic layer to a predetermined temporal relation rule.

8. The context reasoning apparatus of claim 4, wherein the context model is represented as the semantic layer, and includes context knowledge provided by combining the information included in the spatial model, the object knowledge model and the temporal model and a reasoning rule according to applications and services.

9. A context recognition system comprising:
an information gathering apparatus collecting observation data from observational space and obtaining temporal and spatial attribute information for a plurality of objects from the observation data;
a knowledge representation and reasoning apparatus constructing a context representation model using the temporal and spatial attribute information, recognizing current context by performing context reasoning based on the context representation model, and generating an event relating to the current context; and
a service providing apparatus determining an action to be performed by being corresponded to the event generated by the knowledge representation and reasoning apparatus,
wherein the context representation model is composed with an observation layer in which temporal attribute and spatial attribute information for the objects is represented, a syntactic layer in which complex information, provided from the information represented in the observation layer, is represented, and a semantic layer in which semantic information, provided through combination and analysis of the information represented in the observation layer and the syntactic layer, is represented.

10. A context reasoning method for performing context reasoning based on a context representation model composed with an observation layer, a syntactic layer and a semantic layer, the method comprising:
generating observation layer information by using observation data collected in real time to observational space;
generating syntactic layer information by performing spatial reasoning based on the observation layer information;
performing temporal reasoning by using the observation layer information and the syntactic layer information generated at the current point or for a certain period of time; and
producing current context information according to a predetermined reasoning rule by combining at least one information of the observation layer information, the syntactic layer information and the information provided according to temporal reasoning, and performing semantic reasoning.

11. The context reasoning method of claim 10, wherein the performing of temporal reasoning performs at least one chosen from an instant analysis using only information at the current point, a short-term analysis analyzing information records for a certain period of time, and a long-term analysis analyzing information records for a long period of time.
